(19) United States
(12) Patent Application Publication
(10) Pub. No.: US 2021/0163232 A1
(43) Pub. Date: Jun. 3, 2021

(54) DYNAMIC DISPLAY SYSTEM FOR BAGGAGE CAROUSEL

(71) Applicant: Tony Moussa JALLOUL, Dahran Tower (SA)

(72) Inventor: Tony Moussa JALLOUL, Dahran Tower (SA)

(21) Appl. No.: 17/252,155

(22) PCT Filed: Jun. 10, 2019
(86) PCT No.: PCT/IB2019/054824

§ 371 Date: Dec. 14, 2020

Related U.S. Application Data
(60) Provisional application No. 62/684,799, filed on Jun. 14, 2018.

(51) Int. Cl. B65G 43/08; B64F 1/36; G09F 9/302; G06K 9/00

(52) U.S. Cl. CPC B65G 43/08; B64F 1/368; G06K 19/0723; G06K 9/00671; B65G 2201/0264; G09F 9/3026

(57) ABSTRACT

Provided are a method and apparatus for effectively facilitating, via a dynamic display system, a passenger's collection of checked-in bags from carousels of a baggage claim area. The dynamic display system may include: a memory storing instructions; one or more displays; and at least one processor configured to execute the instructions to: obtain the baggage information corresponding to baggage of a passenger, and control to display, in real time during travel of the corresponding baggage along a baggage carousel, the obtained bag information to move, on a screen of the one or more displays, in synchronization with the corresponding baggage along the baggage carousel.

### CROSS-REFERENCE TO RELATED APPLICATION(S)

This application is based on and claims the benefit of U.S. Provisional Application No. 62/684,799, filed on Jun. 14, 2018 in the U.S. Patent and Trademark Office, the disclosure of which is incorporated by reference herein in its entirety.

### BACKGROUND

### 1. Field

Apparatuses and methods consistent with exemplary embodiments relate to facilitating a passenger's collection of checked-in bags from carousels of a baggage claim area.

### 2. Description of Related Art

Baggage handling technology at airports has significantly been developed to provide high security and efficient baggage handling systems. These efforts were and continue to be focused on reducing the number of mishandled bags and improving baggage delivery time in order to avoid flight delay and to minimize passenger waiting times at baggage claim areas.

To this end, the International Air Transport Association (IATA) Resolution 753/A4$ Resolution 30.53, to be implemented by June 2018, intends to encourage airlines to further reduce baggage mishandling by implementing cross-industry tracking for every bag through the journey starting from the check-in point and continuing to arrival belts.

Thus, the main concern of the baggage handling industry has centered on improving and facilitating baggage handling functions for airport and airline teams. The airport and airline baggage handling responsibilities end when the bags are dropped on the carousel conveyor belt at the baggage claim area. The involvement of passengers with the baggage handling system and where passengers experience the most trouble and stress, however, is primarily at the baggage claim area on the arrival belt of the carousel.

With the current baggage claim system, many passengers experience concerns about collecting their bags even long before boarding their flight. At the time of packing their luggage, for example, passengers try to uniquely label their bags in order to easily identify them and distinguish them from similar bags in the baggage claim area. In this regard, some passengers tie colored ribbons or unique accessories to bag handles while others stick decals on the bags.

Identifying bags is not the only concern that worries passengers. Passengers also worry about fraud or theft at the baggage claim area, or from potential mistakes and mix-ups that result in the wrong bags being misidentified and mistakenly taken by other passengers. Where a passenger has packed valuables in checked-in bags, he or she may experience anxiety all flight long, and until the bags are successfully retrieved from the carousel at the baggage claim area.

Passengers who worry about collecting their bags might leave the aircraft upon arrival as quickly as possible to reach the baggage claim area before any other passenger. Some passengers will rush to the baggage claim area to position themselves as strategically as possible, e.g., as near as possible to the area where the bags first arrive on the belt in order to reduce the possibility of somebody else mistakenly taking one of their bags and to minimize their waiting time.

In sum, with the current baggage claim system, passengers can experience many concerns, including: somebody else mistakenly taking their bags; somebody stealing their bags; bag being removed from the carousel by mistake and subsequently lost in the crowd or the airport; mistakenly taking somebody else's bag; and leaving behind one of their bags, which is a potential problem for families travelling with a large number of bags. All these concerns prevent passengers from relaxing and enjoying their journey.

### SUMMARY

Provided are a method and apparatus for effectively facilitating, via a dynamic display system, a passenger's collection of checked-in bags from carousels of a baggage claim area.

According to an aspect of an exemplary embodiment, there is provided a dynamic display system for providing baggage information in real time, the dynamic display system including: a memory storing instructions; one or more displays; and at least one processor configured to execute the instructions to: obtain the baggage information corresponding to baggage of a passenger, and control to display, in real time during travel of the corresponding baggage along a baggage carousel, the obtained bag information to move, on a screen of the one or more displays, in synchronization with the corresponding baggage along the baggage carousel.

The bag information may include at least one of a flight number corresponding to the baggage, a passenger name corresponding to the baggage, a passenger photo corresponding to the baggage, a bag sequence of the corresponding baggage on the carousel, a number of uncollected baggage of the passenger, a departure airport corresponding to the baggage, and a notification of heavy baggage indicating that the corresponding baggage is heavy.

The screen may be a banner screen, ticker screen, or multi-display device that extends along an inner or outer perimeter of the baggage carousel or suspended over the baggage carousel.

The baggage information may be controlled to move at a same speed and a same direction of the corresponding baggage so as to accompany the corresponding baggage as the corresponding baggage travels along the baggage carousel.

The bag information may further include a notification of heavy baggage indicating that the corresponding baggage is heavy.

The at least one hardware processor may be further configured to execute the instructions to, based on the corresponding baggage being removed from the baggage carousel, replace the displayed bag information with an indication of the number of uncollected baggage of the passenger and/or any other predetermined notification and to control to display the indication and/or the predetermined notification for a predetermined period of time.

The dynamic display system may further include at least one of a scanner to identify each baggage loaded onto the baggage carousel.

The dynamic display system may further include: a bag tracking unit for tracking the baggage as the baggage travels along the baggage carousel, wherein the bag tracking unit may include at least one of: a video tracking processing device and one or more cameras; one or more automatic tag reading devices; and one or more Radio Frequency Identification (RFID) readers configured to read an RFID tag on the baggage as the baggage travels along the baggage carousel.

The dynamic display system may further include a cross-platform application server configured to transmit the baggage information to at least one of a user terminal device and an interactive display device.

According to an aspect of another exemplary embodiment, there is provided an electronic device for providing baggage information corresponding to baggage of a passenger, the electronic device including: a memory storing instructions; and at least one processor configured to execute the instructions to: obtain, from a cross-platform application service, the baggage information, and control to display the obtained baggage information corresponding to the baggage of the passenger, the displayed baggage information indicating a real time location of the corresponding baggage on a baggage carousel.

The at least one processor may be further configured to execute the instructions to control to display information guiding the passenger from a flight area to the baggage carousel and information on facilities of an airport in which the baggage carousel is located, the information on the facilities including information on at least one of elevator locations, escalators, stairs, customs and/or passport control area, and specifically-designated or assigned customs and/or passport control lanes.

The at least one processor may be further configured to execute the instructions to control to display a notification whenever checked-in baggage of the passenger is loaded onto the baggage carousel.

The at least one processor may be further configured to execute the instructions to display a notification whenever checked-in baggage of the passenger is removed from the baggage carousel.

The at least one processor may be further configured to execute the instructions to display a notification whenever checked-in baggage of the passenger is removed from the baggage carousel if the passenger is determined to be away from the baggage carousel.

The displayed baggage information may include a scaled down schematic plan corresponding to the baggage carousel, and an indicator of the baggage positioned on and moving along the schematic plan in correspondence with a real time location of the baggage on the baggage carousel.

The displayed baggage information may include a scaled down schematic plan corresponding to the baggage carousel, and indicator of a removed baggage positioned on where the baggage has been removed from, and a time when the baggage has been removed.

According to an aspect of another exemplary embodiment, there is provided a method of providing baggage information in real time, the method including: obtaining the baggage information corresponding to baggage of a passenger; and controlling to display, in real time during travel of the corresponding baggage along a baggage carousel, the obtained bag information to move, on a screen of one or more displays, in synchronization with the corresponding baggage along the baggage carousel, wherein the bag information includes at least one of a flight number corresponding to the baggage, a passenger name corresponding to the passenger, a bag sequence of the corresponding baggage on the carousel, a number of uncollected baggage of the passenger, and a departure airport corresponding to the baggage.

The screen may be a banner screen, ticker screen, or multi-display device that extends along an inner or outer perimeter of the baggage carousel or suspended over the carousel.

The baggage information may be controlled to move at a same speed and a same direction of the corresponding baggage so as to accompany the corresponding baggage as the corresponding baggage travels along the baggage carousel.

According to an aspect of another exemplary embodiment, there is provided a non-transitory computer-readable recording medium having recorded thereon instructions executable by at least one hardware processor to perform the method of providing baggage information in real time.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a layout plan of a direct mounted banner screen for a baggage carousel according to an embodiment;

FIG. 2 is a section view of a direct mounted banner screen for a baggage carousel according to an embodiment;

FIG. 3 is a layout plan of a suspended banner screen installed on top of a baggage carousel according to an embodiment;

FIG. 4 is a section view of a suspended banner screen installed on top of a baggage carousel according to an embodiment;

FIGS. 5 and 6 illustrate an example of bag information displayable by a Dynamic Display Unit according to an embodiment;

FIGS. 7 through 9 illustrate examples of notification messages displayable by a Dynamic Display Unit according to one or more embodiments;

FIG. 10 is a scaled down schematic plan of a baggage carousel;

FIG. 11 is a scaled down schematic plan of a baggage carousel with a bag location identification;

FIG. 12 illustrates a concept layout of a Dynamic Display System (DDS) for a baggage carousel having a flat plate carousel unit according to an embodiment;

FIG. 13 illustrates a relationship between Dynamic Display System units and a method of operating a baggage handling system according to an embodiment;

FIG. 14 is a flowchart of a method of guiding passengers to a baggage claim area according to an embodiment;

FIG. 15 illustrates DDS scanner components according to an embodiment;

FIG. 16 illustrates a sample of a simulated tracking reference according to an embodiment;

FIG. 17 is a flowchart of a method of operating a DDS scanner according to an embodiment;

FIG. 18 is a flowchart of a method of tracking a bag on a baggage carousel according to an embodiment;

FIG. 19 is a flowchart of a method of operating a Dynamic Display Unit according to an embodiment; and

FIG. 20 is a flowchart of a method of operating a Dynamic Display Unit when a bag is removed from a baggage carousel, according to an embodiment.

### DETAILED DESCRIPTION

The terms used in the present disclosure are only used to describe specific embodiments, and are not intended to limit the present disclosure. A singular expression may include a plural expression unless plainly different according to a context. Unless defined otherwise, all terms used herein, including technical and scientific terms, have the same meaning as those commonly understood by a person of ordinary skill in the art to which the present disclosure pertains.

The expressions “A and/or B,” “A or B,” “at least one of A and B,” “at least one of A or B,” “one or more of A and B,” and “one or more of A or B,” as used herein, may include all possible combinations of the items that are enumerated together. For example, the term “A and/or B” or “at least one of A and B” may designate (1) at least one A, (2) at least one B, or (3) both of at least one A and at least one B.

Hereinafter, various embodiments will be described based on hardware implementations. However, various embodiments include a technology that uses both hardware and software and thus, various embodiments may not exclude software implementations.

One or more exemplary embodiments provide a system that transmits, in real time, information of passengers' checked-in bags after reaching a baggage claim area. This system provides the concrete, useful, and tangible result of facilitating the efficient and easy collection of passengers' checked-in baggage through a practical application using large displays of real time baggage information. Displayed information accompanies the bag through its travel on the carousel. To this end, the system transmits, in real time, the time that a bag is loaded to the carousel, the time that a bag is removed from the carousel, and/or information related to the exact location of each bag on the carousel. The system also reminds passengers about the total number of checked-in bags and informs passengers on how many bags are yet to be collected to avoid mistakenly leaving behind any bags, inadvertently collect anybody else's bags, etc.

A Dynamic Display System (DDS) according to one or more embodiments includes a processing unit (e.g., at least one processor, at least one processing device, at least one control station, etc.) that controls and manages four main components or functions: a Dynamic Display Unit (DDU); a BagClaim Cross-Platform Application Unit for Smartphone and Tablets; a Short Message Service Unit; and an Interactive Display Unit.

1. Dynamic Display Unit

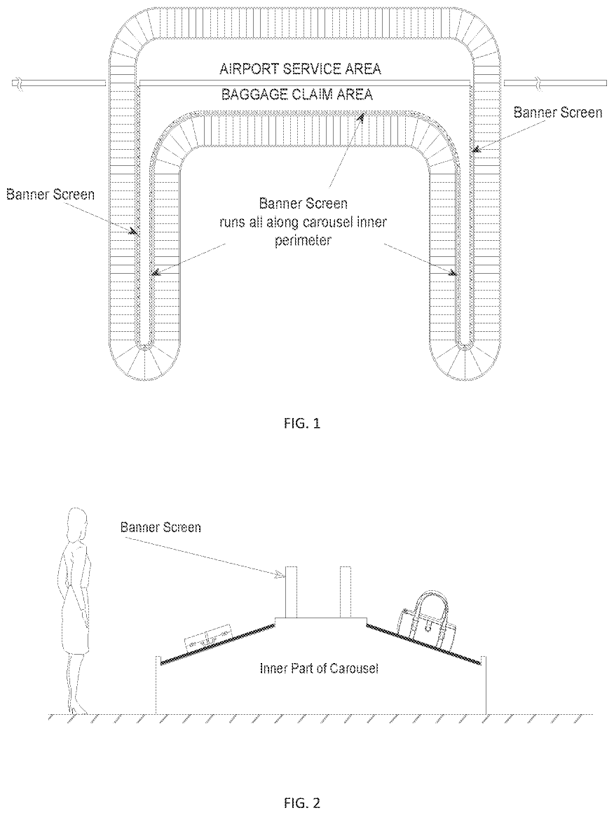

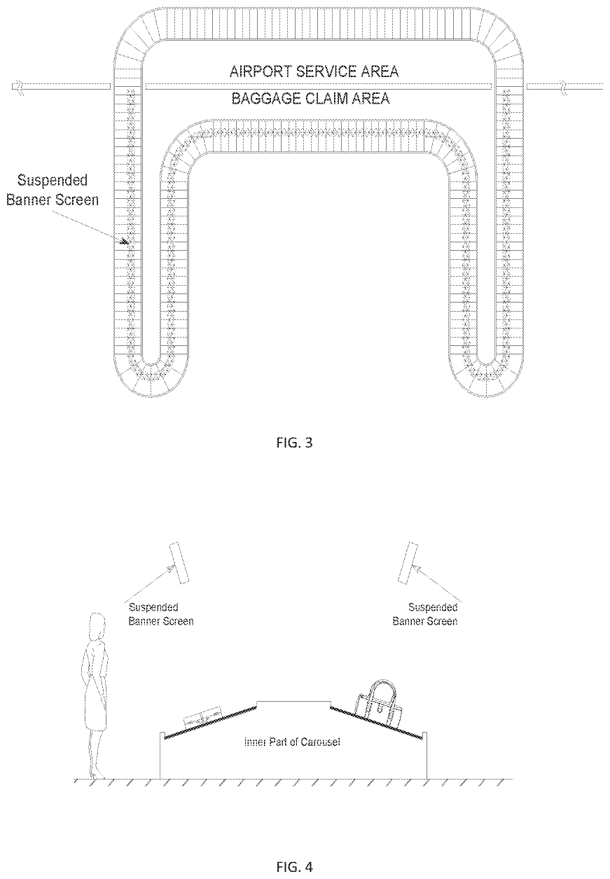

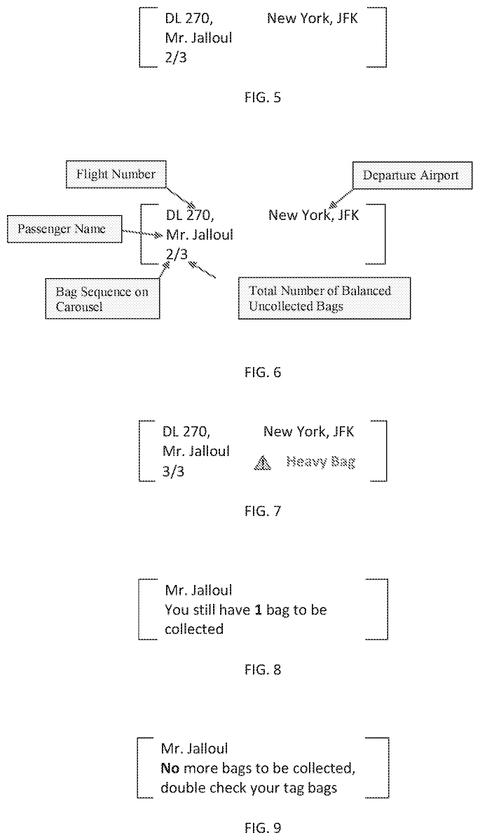

A Dynamic Display Unit (DDU) according to one or more embodiments will now be described with reference to FIGS. 1 through 9. In particular, FIGS. 1 and 2 are views of a direct mounted banner screen for a baggage carousel according to an embodiment. FIGS. 3 and 4 are views of a suspended banner screen installed on top of a baggage carousel according to an embodiment. FIGS. 5 and 6 illustrate an example of bag information displayable by a DDU according to an embodiment. FIGS. 7 through 9 illustrate examples of notification messages displayable by a DDU according to one or more embodiments.

The Dynamic Display Unit (DDU) according to various embodiments provides bag information largely displayed to accompany corresponding baggage (e.g., luggage) as it travels along the carousel (e.g., in real time synchronization on a screen of one or more displays with the corresponding baggage as it travels along the baggage carousel). For example, the DDU may use a banner screen as a display option that is installed and runs all along the inner perimeter of the carousel (e.g., extends adjacent to the inner perimeter of the carousel), as shown in FIGS. 1 and 2, or that is suspended above a carousel conveyor belt as shown in FIGS. 3 and 4. As a result of this banner display of bag information, monitoring of baggage is facilitated and improved, and passengers can avoid confusion with respect to look-alike bags (i.e., bags that look like, but are not, a passenger's).

As a bag travels on the carousel, the banner screen displays information related to the bag. This information may move on the screen at the same speed and same direction of the corresponding bag so as to accompany the bag all through its travel on the carousel. It is understood, however, that this is merely an example, and one or more other embodiments may not be limited to a movement of the information at the same speed as the bag. For example, according to another embodiment, the information may move on the screen at predetermined intervals (e.g., may move from one portion of the banner screen to another portion of the banner screen at predetermined time intervals or as the bag travels from one distance interval to another, e.g., every five meters). Further, while the present embodiment is described with reference to a banner screen or ticker screen, it is understood that one or more other embodiments may not be limited thereto. For example, according to another embodiment, a plurality of display devices or screens may be positioned along the barrage carousel (e.g., at predetermined distance intervals), with each display device or screen displaying bag information of one or more corresponding bags located within a corresponding portion of the baggage carousel.

As a result of the DDU's display of bag information as described above, passenger confusion or mistakes with respect to look-alike baggage can be reduced, since the corresponding bag information is displayed relative to (e.g., above) the baggage (e.g., on a banner screen) as the baggage travels along the carousel. This also reduces the need to hastily check the printed tag of the bag while it is moving and eliminates the need to remove the bag from the carousel to read its label.

By way of example, bag information could include at least one of a Flight Number, a passenger name, a passenger photo, a bag sequence on the carousel, a number of passenger's uncollected bags (e.g., 3 out of 5 bags collected, 2 out of 5 bags uncollected, etc.), a departure airport, etc., as illustrated in FIGS. 5 and 6. It is understood that one or more other embodiments may not be limited thereto, and the displayed information could vary in accordance with, for example, the wishes and requirement of an airline and/or airport authority. In this regard, it is understood that any of the message design, layout, and contents may vary in other embodiments.

As described above, the displayed message (i.e., bag information) distinctly and unmistakably identifies the owner of a bag. Further, bag sequence information may also be provided to inform a passenger if there are any bags ahead of where he is positioned relative to the carousel. Moreover, the display may also show an uncollected bags balance (i.e., a number of the passenger's uncollected bags) so that a passenger (e.g., a tired passenger or a passenger with a large number of checked-in bags) will not mistakenly leave behind any bag.

The displayed message may also provide a notification of a heavy or overweight bag (e.g., a bag that has a weight greater than a predetermined weight, and/or has been designated as a heavy or overweight bag by an operator or user), such as exemplarily illustrated in FIG. 7. This type of information can inform other passengers to give more space for a passenger to pick up or retrieve his heavy bag.

When a bag is removed from the carousel, the displayed bag information may be replaced by a notification (e.g., a short notification message) on the display (e.g., banner screen) to inform the passenger of the uncollected bags balance (i.e., the number of the passenger's bags that are yet to be retrieved), such as is exemplarily illustrated in FIGS. 8 and 9. This message may appear for a predetermined period of time (e.g., five seconds seconds) before disappearing.

In one or more embodiments, the DDU (e.g., banner screen of the DDU) may also be used for other purposes, such as to display advertising messages, general flight information, news information, broadcasting content, etc. Such other use may be simultaneous with the display of bag information (e.g., in areas of the display screens not occupied by the bag information, or with the bag information overlaying or superimposed over the other content) or during times when the carousel is not being used to deliver bags.

2. Cross-Platform Application for User Terminal Device

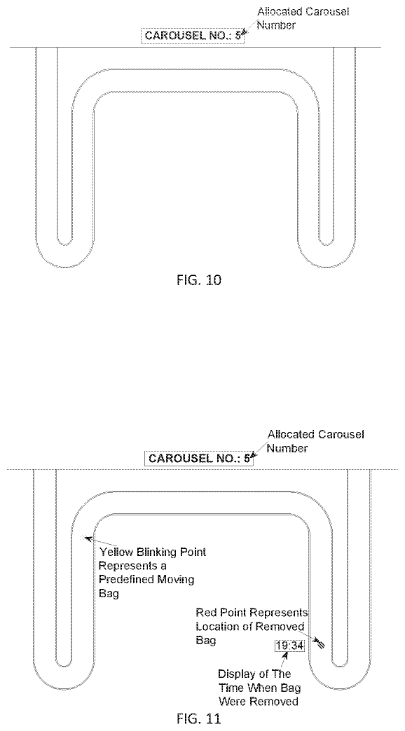

A user terminal application for assisting a passenger in the collection of his or her baggage in accordance with one or more embodiments will now be described with reference to FIGS. 10 and 11. In the present embodiment, a cross-platform application for smartphones and tablets (e.g., BagClaim application) is described by way of example, but it is understood that one or more other embodiments are not limited thereto. That is, one or more other embodiments may be implemented as an application for any user terminal device (e.g., portable multimedia player, wearable device, smart watch, smart accessory, laptop computer, etc.) including a memory storing instructions and at least one processor configured to execute those instructions.

According to the present embodiment, a cross-platform application for smartphones and tablets is configured as instructions executable by at least one processor to perform at least one of the following operations: to guide passengers to easily reach a baggage claim area and find an allocated carousel for their flight; to notify a passenger whenever (or based on) one of his or her checked-in bags is loaded onto the carousel; to transmit to a passenger in real time location information of his or her bag(s) on the carousel (or upstream of the carousel, e.g., while still loaded on the airplane and/or while in transit from the airplane to the baggage claim or carousel area); and to alarm or notify a passenger if one of his or her bags is removed from the carousel by somebody other than the passenger (e.g., while the passenger is detected as being away from the baggage or the carousel area, e.g., outside a predetermined area corresponding the baggage carousel area).

The cross-platform application according to one or more embodiments can function as a standalone application (e.g., BagClaim application), or can be integrated within another application, e.g., an airline's dedicated mobile application, an airport's mobile application, a website, as a sub-module to provide end users with a single platform to deal with, and vice versa.

2.1 Carousel Guide Function

First, a carousel guide function (e.g., a Carousel Guide Module) of the cross-platform application according to an embodiment will be described. The carousel guide function or module provides passenger notifications and direction guidance to reach an allocated carousel or claim area corresponding to a passenger's flight.

This module may be customized for each airport, and can help passengers find their way with less confusion and with more confidence in the crowd. This is particularly useful for a new airport that passengers may not be as familiar with. Furthermore, this module may be configurable to provide different modes or settings for degrees of detailed information to be provided.

For example, one mode or option may provide a scaled down carousel schematic plan reflecting the actual layout plan of the allocated carousel with a small text box that identifies a number (e.g., reference number) of the allocated carousel, as shown in FIG. 10. This mode may be useful for passengers who are familiar with the airport and do not need any detailed guidance (e.g., direction guidance) to reach the baggage claim area.

Alternatively, another mode or option may provide passengers with a two-dimensional (2D) or three-dimensional (3D) layout plan of the path that the passenger should take to reach a baggage claim area, starting from the arrival terminal gate all the way to the baggage claim area. Under this mode, the Carousel Guide Module can identify or distinguish the allocated carousel, e.g., by highlighting the allocated carousel. One advantage of this mode or sub-module is that, according to an embodiment, it can provide information on all the facilities provided by airport that could be used, such as elevator locations, escalators, stairs, customs and/or passport control areas, specifically-designated or assigned customs and/or passport control lanes (e.g., citizens, non-citizens, expedited processing, GLOBAL ENTRY, etc.), etc.

2.2 Notification Function

Next, a notification function (e.g., Message Notification Module) of the cross-platform application according to an embodiment will be described. This function or module can notify a passenger when his or her bag has reached a baggage claim area via, for example, at least one of a push notification, an email, a short message service (SMS) message, etc., whenever the bag reaches a predetermined destination (e.g., whenever the bag is loaded to the carousel). The notification function or module can also notify a passenger of his or her uncollected bag balance, e.g., “Mr. XXX, you have got 1 out of 3 bags loaded to carousel No.: 5.”

By this notification function, the cross-platform application according to an embodiment (e.g., the BagClaim application) can enhance a user experience and user convenience. For example, by being provided with notifications regarding ones checked-in luggage, a passenger need not rush or go directly to the allocated carousel to wait for his bags. Rather, a passenger can feel free to enjoy the amenities of the airport, such as shopping, eating, resting, socializing, etc. This function can also reduce the crowds at the baggage claim area or carousel area and improve or increase passenger satisfaction.

2.3 Bag Locator Function

Next, a real time bag locator function (e.g., Bag Guide module) of the cross-platform application according to an embodiment will be described. When a bag is loaded to the carousel, this function or module notifies the passenger, in real time, of his or her bag's location on the carousel. For example, by this function, the cross-platform application may display a scaled down schematic plan reflecting the actually allocated carousel with a blinking and moving yellow point that identifies in real time where the bag is. In this case, the blinking and moving yellow point moves in the same direction and same proportional speed as the actual bag does, as shown in FIG. 11. It is understood, however, that one or more other embodiments are not limited to this example, and may identify or distinguish the passenger's bag in any manner (e.g., via the use of any identifier such as an icon, a mark, a symbol, an image, a name of the passenger, a reference number for the bag, etc.). Additionally, the real time identification of the bag location need not be a continuously-moving display of an identifier of the bag in one or more other embodiments. For example, according to another embodiment, the real time bag locator may identify a predetermined section or portion of the carousel in which the passenger's bag is located. Ultimately, the real time bag locator function, allows a passenger to quickly find and retrieve his or her bag(s) upon reaching an allocated carousel. Thus, bags can be retrieved more efficiently and expeditiously, reducing wait times, crowds around the carousel, and the inconvenience of having to search for one's bags on the carousel.

Further, when a bag is picked up (or based on the bag being picked up) from the carousel, the identifier of the bag may disappear or may change to indicate a location at which the bag is removed from the carousel. For example, the blinking and moving yellow point may change to a fixed red point on the schematic showing where the bag is removed from the carousel. Additional information may also be provided, such as a text box that appears near the fixed red point and providing the bag removal time, as shown in FIG. 11. Additional or different information (such as a remaining or uncollected baggage balance) may also be provided in one or more other embodiments.

In a case where a bag is removed from the carousel (e.g., mistakenly or by an airline or airport attendant) and not returned to the carousel, the indicator of the location at which the bag is removed (e.g., the fixed red point described above) can allow a passenger to quickly identify an area around which the bag may be found, i.e., an area near the location of the carousel at which the bag was removed. In other words, if a passenger's bag is mistakenly taken from the carousel and not returned on to the carousel, the indicator can immediately notify the passenger as to the area where his or her bag was removed.

2.4 Bag Removal Alarm Function

Next, a bag removal alarm or notification function (e.g., Bag Removal Alarm) of the cross-platform application according to an embodiment will be described. According to the present embodiment, the cross-platform application can provide passengers with the option to activate an alarm notification (e.g., sound or haptic alarm) to alert them when one of their bags is removed (or based on one of their bags being removed) from the carousel. For example, when the cross-platform application notifies a passenger that his bags are available to pick up from the carousel (via, for example, the above-described notification function), the application can also provide the passenger with the option to activate the bag removal alarm.

By being immediately alerted to a bag removal via this alarm, a passenger can quickly address a situation whereby his or her baggage has been taken. For example, the passenger can go directly to the location indicator of the bag removal (e.g., the red fixed point described above) to look around. If the passenger cannot find his or her bag, the passenger can immediately notify the airline or security within minutes of the bag being taken.

As described above, the cross-platform application according to one or more embodiments can increase passenger convenience and decrease passenger concern when away from a baggage carousel. Further, the cross-platform application can reduce crowds around a baggage carousel, increase efficiency of baggage retrieval, and provide real-time and/or immediate notifications with accurate reference times for tracking baggage and preventing or minimizing the risk of baggage being mistakenly taken or stolen.

3. Short Message Service

As set forth above, the DDS according to one or more embodiments may include a Short Message Service (SMS) unit or function. This function can use a passenger registered mobile phone or SMS number to send the passenger a notification related to his or her bag(s) when loaded to the conveyor or carousel (or another predetermined point). This function may also or may instead notify a passenger when his or her bag(s) is unloaded from the carousel on a bag-by-bag basis (e.g., a message transmitted for each bag) or based on a passenger's first bag and/or a passenger's last bag being removed or unloaded.

4. Interactive Display Unit

The DDS according to one or more embodiments may also include an interactive display unit (or interactive display device). The interactive display unit may include at least one of an interactive touch screen (or other input devices for obtaining a user input, such as a keyboard, a plurality of buttons, a rotatable dial, a voice input device, etc.), a bar code reader, and a radio frequency identifier (RFID) reader. The interactive display unit may also include a memory storing instructions and at least one processor configured to execute the instructions to provide a passenger with access to at least one of the functionalities described above with reference to the cross-platform application according to one or more embodiments. For example, the interactive display unit may allow a passenger to input his flight or ticket (e.g., e-ticket) number directly using the interactive touch screen and/or to scan his boarding pass or his bag claim ticket by an Automatic Tag Reader (e.g., bar code reader) so as to provide access to the cross-platform application (e.g., BagClaim Application) described above.

5. Operation

As described above, the DDS according to one or more embodiments includes at least one of a Dynamic Display Unit (DDU); a BagClaim Cross-Platform Application Unit for Smartphone and Tablets; a Short Message Service Unit; and an Interactive Display Unit.

In addition to these components, which provide an interface for a user (or passenger), the DDS may also include at least one of: a DDS scanner; a Bag Tracking Unit (e.g., bag tracker); and a DDS Process Unit (e.g., DDS processor or processing device).

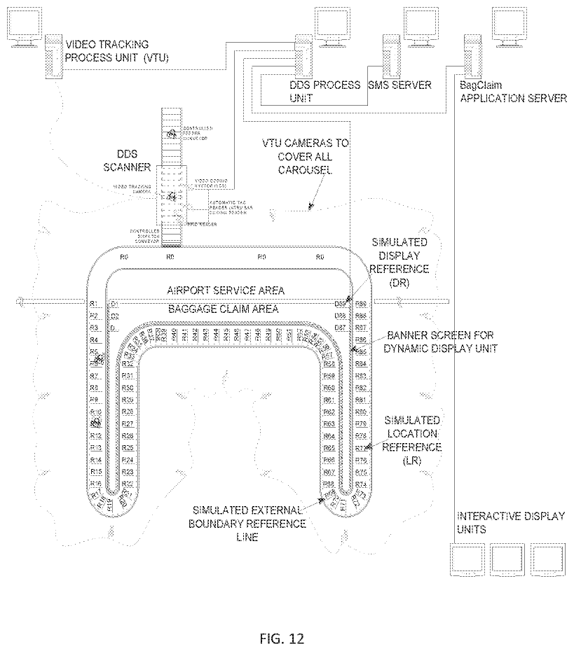

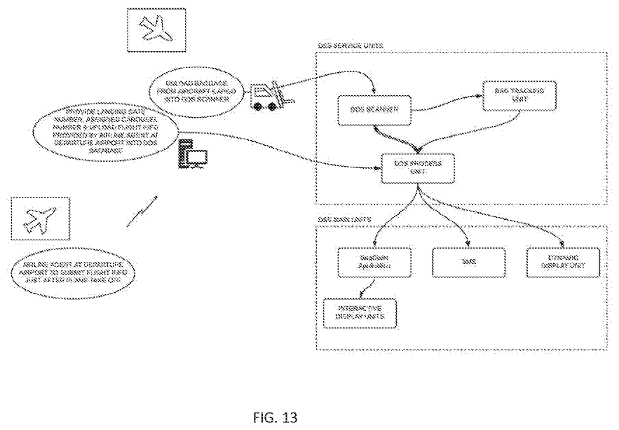

FIG. 12 is a concept layout of a Dynamic Display System (DDS) for a baggage carousel having a flat plate carousel unit according to an embodiment. FIG. 12 illustrates a concept layout of a DDS for a baggage carousel according to an embodiment. In FIG. 12, a flat plate carousel with a banner screen DDU that runs all along the inner part of the carousel is provided as an example, though it is understood that one or more other embodiments are not limited thereto. Also, FIG. 12 shows a sample set of three Interactive Display Units. By way of example, these Interactive Display Units can be installed at arrival landing gates and at a baggage claim area to be easily accessible to passengers who may not have access to the cross-platform application (e.g., the BagClaim application). It is understood, however, that one or more other embodiments are not limited thereto, and any number of and location for Interactive Display Units may be provided. FIG. 13 illustrates a relationship between Dynamic Display System units and a method of operating a baggage handling system according to an embodiment.

Referring to FIGS. 12 and 13, each baggage claim carousel for the DDS system is equipped with at least one DDS scanner. The DDS scanner may be installed in an airport service area that allows a baggage handeling team to scan each bag through the DDS scanner prior to reaching a carousel conveyor belt.

A Bag Tracking Unit according to an embodiment may be provided as a video tracking system that includes a Video Tracking Process Unit (VTU) (e.g., video tracking processing device) and one or more cameras that are provided around a carousel to cover the baggage claim carousel at both a baggage claim area and an airport service area. The number, layout, and positioning of cameras may vary in one or more embodiments, and may be based on a carousel type, a carousel size, a carousel design, etc. According to one or more other embodiments, the Bag Tracking Unit may include Automatic Tag Readers and/or RFID Readers for purposes of locating the bag on the carousel in addition to or in lieu of video tracking devices and cameras. For example, each bag can include an RFID tag (for example, as part of a baggage claim check tag) added to the bag on check-in, and the carousel can include RFID readers at predetermined intervals or along the entirety of the carousel and/or baggage claim area. It is understood that one or more other embodiments are not limited to cameras and/or RFID readers for the Bag Tracking Unit, and can use any means for locating and/or tracking an object.

Next, the DDS Process Unit may be implemented as a computer-based software (e.g., at least one processor configured to execute instructions stored in memory) for controlling and/or managing the DDS as a whole. For example, the DDS Process Unit may operates and/or control the DDS Scanner and the DDU. Further, the DDS Process Unit may interface with and/or provide information to run the Short Message Service Unit (e.g., SMS Server) and the cross-platform application server (e.g., BagClaim Application Server). The DDS Process Unit may also interact with the Bag Tracking Unit to receive real-time and updated information on bag location and status. The DDS Process Unit may further provide a simple interface to an administrator (e.g., operating team) in order upload, store, and/or update 2D and 3D airport maps, upload, store, and/or update flight information data, set allocated gates and carousels, customize messages for the DDU and/or cross-platform application (e.g., BagClaim Application), set and modify any other operating parameters, etc.

To meet the uniqueness of each airport, the DDS Process Unit according to one or more embodiments may have a tailored setup at installation, e.g., to generate and/or define simulated location references for carousels and display references for DDUs.

Here, the simulated location references may be a set of virtually-simulated positioning reference lines generated or provided by the DDS Process Unit to define the external boundary of the carousel and to accurately reflect a defined location reference on a carousel. The setup of location references may take place after completing the installation of the Bag Tracking Unit, e.g., video tracking camera that provide a full image view of the carousel. FIG. 12 illustrates a sample of simulated location references (LR) on the carousel that are labeled R1, . . . R89, while R0 refers to carousel location inside an airport service area. The number and spacing of location references may be defined based on carousel size, layout, and/or level of required accuracy. By this set up, the Bag Tracking Unit can alert the DDS Process Unit each time a defined bag reaches a particular location reference.

According to an embodiment, the DDS Process Unit establishes or provides a simulated display reference (DR) for the DDU facing each location reference line. To simplify the drawing, FIG. 12 illustrates only the first three Display References and the last three Display References that are labeled D1, D2, D . . . , D87, D88, and D89, though it is understood that each defined location reference (LR) on the carousel has an equivalent and unique display reference at the DDU. According to one or more other embodiments, there may be a many-to-one ratio of location references to display references (e.g., one display reference for every five location references).

5.1 Electronic Claim Ticket and Carousel Guide

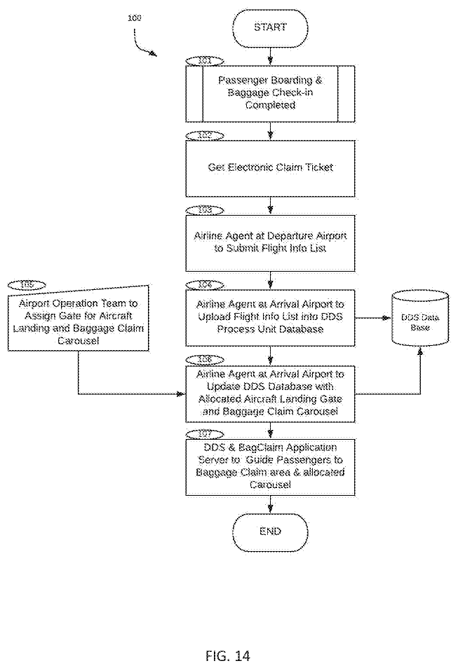

FIG. 14 is a flowchart of a method (100) of guiding passengers to a baggage claim area according to an embodiment. Referring to FIG. 14, before boarding an aircraft, passengers typically have to complete a check-in process that includes three main steps: validating a passenger's documents; checking in baggage that is to go in the aircraft's cargo area (101); and issuing a boarding pass and a baggage claim ticket (102).

In addition to the traditional check-in counter at airports, the air transport industry is investing in new technologies and new types of services to provide passengers with a more flexible and convenient check-in process. For example, an Automated Check-in/Self Check-in service and an In Town Check-in service are becoming more common and widespread. Regardless of the type of check-in service, all these service types provide functionality for achieving the aforementioned three steps of the check-in process.

After checking in baggage, a passenger generally receives baggage claim tickets reflecting information of respective tags attached to their bags (e.g., Passenger First Name/Last Name, Destination, Date of Receiving Bag, Number of Bags, Weight of each Bag, etc.). Passengers are expected to keep the claim tickets with them until they retrieve their bags at their destination. Using the cross-platform application according to an embodiment (e.g., BagClaim application), a passenger can receive an electronic claim ticket (e.g., eclaim ticket) instead of (or in addition to) printed claim tickets. The electronic claim ticket may be provided as at least one of a message via the cross-platform application, an SMS message, an email, etc. To achieve this, an application server for the cross-platform application can connect with and communicate with a server for an airline or an airport to request and/or receive the electronic claim ticket (or information to be provided in the electronic claim ticket, to be used for generating the electronic claim ticket at the application server or directly by the application). Alternatively, the cross-platform application can simply connect directly to the airline or airport server to request and/or receive the electronic claim ticket (or information to be provided in the electronic claim ticket, to be used for generating the electronic claim ticket by the application). This service will eliminate the need to hold printed claim tickets all flight long and eliminate the concern of losing the printed claim tickets.

After flight boarding is completed, an airline agent at a departure airport will have a full list of onboard passengers together with a list of checked-in baggage. This information is provided to the Dynamic Display System for Baggage Carousel (DDS) according to an embodiment (103 and 104), e.g., by uploading to a database or a DDS Process Unit. In one or more embodiments, this information may be submitted each time a customer checks in luggage, or at the time that flight boarding is complete for all passengers, though it is understood that one or more other embodiments are not limited thereto. For example, as shown in the embodiment of FIG. 13, this information may be provided to an airline or airport agent at an arrival airport, for submission or uploading to the DDS Process Unit (or a database thereof). Table 1 shows a sample of information used by the DDS. By way of example, the information as exemplified in Table 1 below may be sent to the flight destination (e.g., an agent of the airline or airport at the flight destination) as early as boarding and completion of baggage loading.

TABLE 1
Sample of DDS Required Information from Departure Airport

| | | | | | Bag Tag | | Bag |
|---|---|---|---|---|---|---|---|
| Passenger | Mobile | Flight | Departure | | Identification | Bag | Weight |
| Name | Number | No. | Airport | ETicket No. | Code | Sequence | (kg) |
| Mr. Jalloul | +xxxxxx | DL 270 | New York, | 0762625351102 | 2300101010 | 1 | 17.6 |
| | | | J F K | | | | |
| Mr. Jalloul | +xxxxxx | DL 270 | New York, | 0762625351102 | 2310101011 | 2 | 12.4 |
| | | | J F K | | | | |
| Mr. Jalloul | +xxxxxx | DL 270 | New York, | 0762625351102 | 2450101111 | 3 | 37.2 |
| | | | J F K | | | | |
| Mr. Johan | +xxxxxx | DL 270 | New York, | 0762625517046 | 2450140231 | 1 | 11.5 |
| | | | J F K | | | | |

In the embodiment of FIG. 14, an airline agent at an arrival airport receives the above-described information and uploads the same into a DDS database (104). As described above, however, one or more other embodiments are not limited thereto. For example, according to one or more other embodiments, this information may be provided to the DDS (e.g., uploaded to the DDS database) from an agent at the departure airport, or directly from a server of the airline or the airport.

The DDS system also obtains information on an assigned baggage carousel. For example, an airport operation team, at arrival, assigns a gate for aircraft landing and a carousel at a baggage claim area for passengers to receive their baggage (105). This information is uploaded or inputted to the DDS, e.g., a DDS Database (106) to allow the cross-platform application (e.g., BagClaim application) to guide passengers to an allocated carousel starting from a landing gate (107).

5.2 DDS Scanner

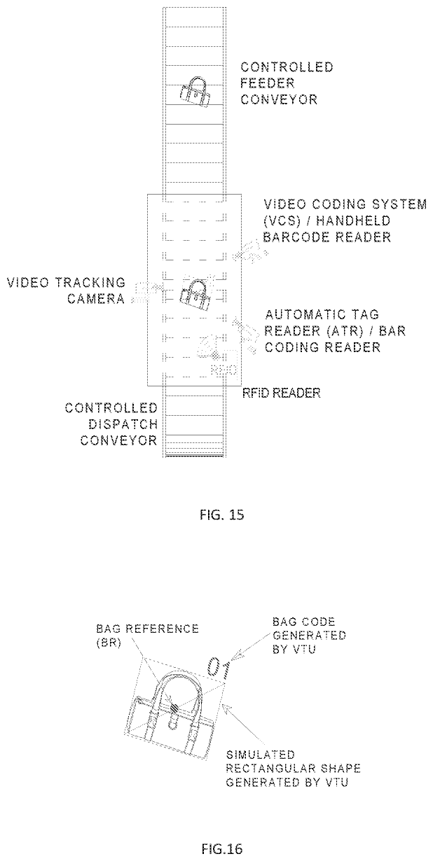

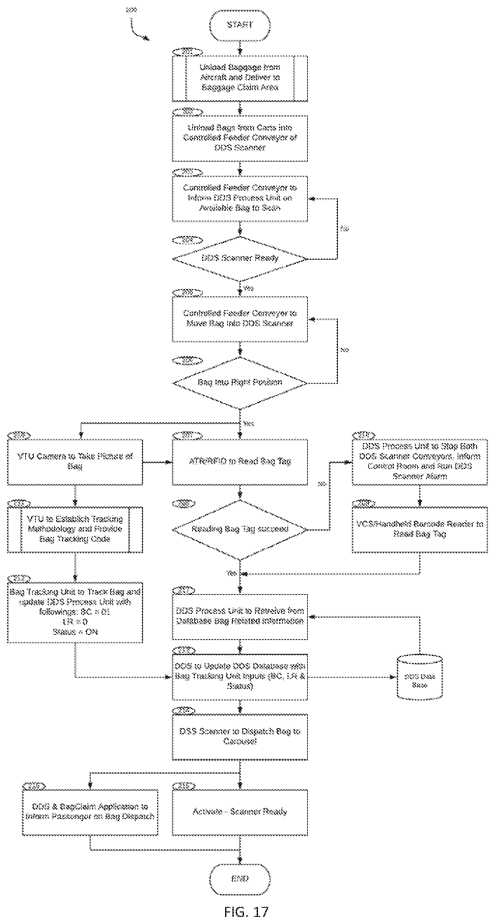

FIG. 15 illustrates a DDS scanner system according to an embodiment, FIG. 16 illustrates a sample of a simulated tracking reference according to an embodiment, and FIG. 17 is a flowchart of a method (200) of operating a DDS scanner according to an embodiment. Referring to FIGS. 15 to 17, after unloading baggage from an aircraft's cargo area per a typical or conventional unloading process (201), bags are loaded one-by-one onto the DDS scanner (202), e.g., the controlled feeder conveyor of the DDS scanner, as exemplarily shown in FIG. 15. The DDS scanner provides references for bag tracking over a carousel to the DDS system, e.g., by transmitting the references to the DDS Process Unit, to tie these references to the information of the bag checked-in at the departure airport. To this end, the DDS scanner according to an embodiment (FIG. 15) may include at least one of: a controlled feeder conveyor; a controlled dispatch conveyor; an automatic tag reader (ATR), an automatic barcode reader; a video coding system (VCS), a handheld barcode reader; an RFID reader; a video tracking camera tied to a video tracking system, etc.

The controlled feeder conveyor is equipped with sensors to detect baggage that is loaded. Thus, based on the bag being loaded on the controlled feeder conveyor (e.g., the moment the bag is loaded), the system (e.g., a processor included in the DDS scanner and configured to execute instructions to perform the method or functionality of the DDS scanner) informs the DDS Process Unit (203). For example, a signal, data, or information indicating the presence of a bag ready for scanning is transmitted to the DDS Process Unit. The DDS Process Unit can check or confirm the availability of the DDS scanner (204).

When the DDS scanner is ready (or based on the DDS scanner being determined or confirmed as ready) (204), the DDS Process Unit instructs or controls the controlled feeder conveyor to deliver the bag into the DDS scanner (205 and 206).

As the bag travels along the controlled feeder conveyer, the DDS scanner (e.g., an automatic tag reader (ATR) and/or a radio-frequency identification (RFID) reader) scans, detects, and/or reads a tag attached to the bag to allow the DDS Process Unit to identify the bag (207).

In case the tag attached to the bag is damaged and/or could not be read for any reason by the ATR or the RFID reader (No at 208), the DDS Process Unit instructs at least one of the controlled feeder conveyor and the dispatch conveyor to stop (218). In this case, the DDS Process Unit may inform or notify an administrator or a control room to use a video coding system (VCS) to read a bag tag or otherwise identify a bag. Further, the conveyors may be stopped and an alarm (e.g., a sound and/or a warning light) may be triggered at the DSS scanner, to give notice to an employee or worker who is unloading bags to use a local handheld barcode reader to read the tag or to input tag information manually (209). After reading the bag's tag, the DDS Process Unit retrieves (e.g., from the DDS database) the bag related information that was previously obtained (as provided, for example, with reference to FIG. 14) (217).

As the bag moves through the DDS scanner, the camera of a video tracking system inside the DDS scanner can capture one or more images of the bag 210. The one or more images of the bag can be processed by a video tracking process unit (VTU) to establish or obtain a tracking reference methodology (211) and to establish or obtain a Bag Code (BC) and a Bag Reference Point (BR), as illustrated in FIG. 16. The moment the VTU completes the process of establishing tracking references, the DDS Process Unit is updated with a BC, a BR, and a Status (212).

The DDS Process Unit merges or inputs the information or data of the new fields of the video tracking process unit into related DDS Database fields. Using the identification tag attached to the bag and receiving inputs of the video tracking process unit, the DDS Process Unit updates the DDS Database as detailed in Table 2 (213) to tie the bag information together with the tracking bag code.

TABLE 2
Sample of Linking Tracking References to Bag Tag Information

| Retrieve Bag information from DDS Database based on Bag | | | | | | | | | | |
|---|---|---|---|---|---|---|---|---|---|---|
| Tag reading by ATR/RFID/VCS or Handheld Barcode Reader | | | | | | | Inputs of Bag Tracking Unit | | | DDS Process |
| | | | | | Sequence | Bag | Bag | | | Unit Input |
| Passenger | Flight | Departure | | Bag Tag | Number | Weight | Code | | | Dispatch |
| Name | No. | Airport | ETicket | Bar Code | of Bag | (kg) | (BC) | Status | LR | Time |
| Mr. Jalloul | DL 270 | New York, | 0762625351102 | 0100101010 | 1 | 17.6 | 01 | On | R0 | 17:18 |
| | | J F K | | | | | | | | |

The DDS Process Unit instructs or controls the controlled dispatch conveyor to deliver the bag onto the carousel (214). The moment the bag exits the DDS scanner or based on the bag being determined to exist the DDS scanner (or a predetermined area), the DDS Process Unit activates a scanner readiness (215). At this time, the DDS notification mechanisms (e.g., an SMS notification service or a notification function of the cross-platform application, e.g., BagClaim application) inform a passenger on the dispatched bag (216). In this case, the DDS Process unit may execute instructions to transmit information and/or a control signal to the SMS service (e.g., server) and/or cross-platform application or application server.

5.3 Bag Tracking System

A bag tracking system according to an embodiment tracks a bag (e.g., a bag code that has gone through the DDS scanner according to an embodiment) by reference information, e.g., a Bag Code (BC), across a carousel, and updates the DDS Process Unit with at least one of a bag Location Reference (LR) and a bag Status.

The bag tracking system may use at least one of a video tracking system and an automatic tag reader (ATR). For example, automatic tag readers may be used to define or determine a bag Location Reference (LR).

A video tracking system according to an embodiment uses object tracking technology to track a bag across the carousel. For example, a camera of the video tracking system of the DDS scanner may capture an image of a bag that is subsequently used by the video tracking process unit (VTU) to establish one or more tracking references (e.g., tracked via object recognition image processing technology).

Further, the VTU or the back tracking system of the present embodiment tracks a defined bag by Bag Code (BC) throughout the carousel conveyor, and updates the DDS Process Unit on the bag's location every time the bag reaches a new Location Reference (LR) or when the bag crosses the carousel limit line (Status). Accordingly, whenever the bag reaches a new Location Reference, the VTU or the back tracking system transmits a Bag Code (BC) and the updated Location Reference (LR) to the DDS Process Unit and whenever the bag exists the carousel, VTU or the bag tracking system directly alerts the DDS Process Unit by changing a Status of the related Bag Code from a first state (e.g., ON) to a second state (e.g., OFF).

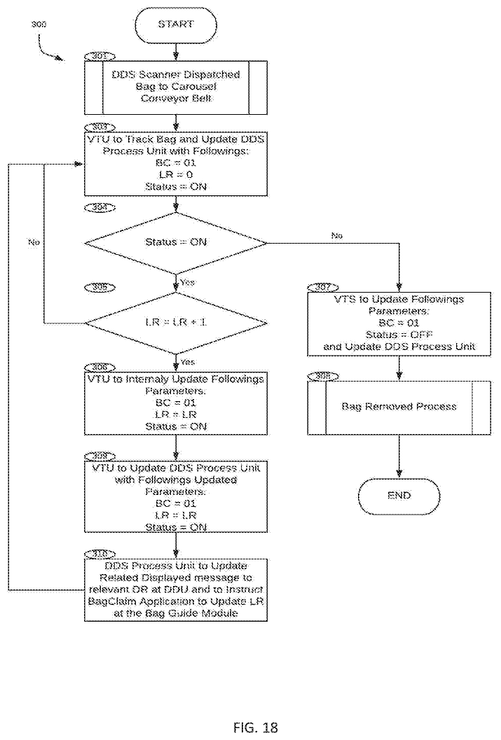

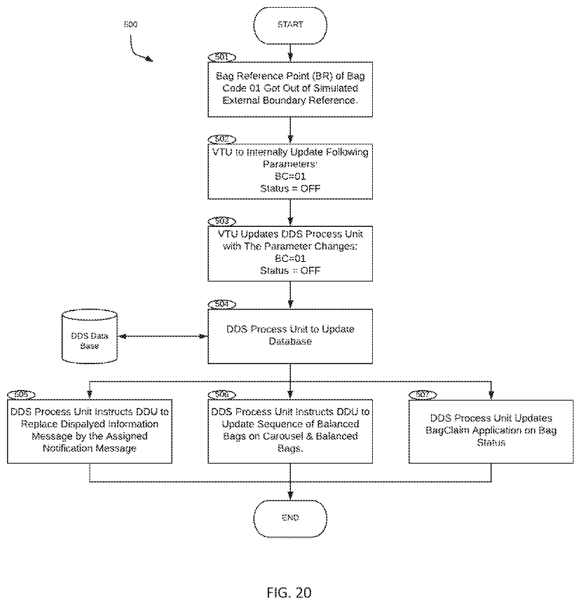

FIG. 18 is a flowchart of a method (300) of tracking a bag on a baggage carousel according to an embodiment. Referring to FIG. 13, upon reaching a predetermined point (e.g., an exit or end of a DDS scanner (301)), the bag tracking system (e.g., a video tracking unit or a processing device with at least one processor configured to execute instructions to track luggage on a carousel) begins tracking the bag by the predefined Bag Code (e.g., “BC=01”). In the present example, after being dispatched from the DDS scanner, a bag reaches a carousel at an airport service area having a Location Reference, LR=R0, and Bag Status=ON (303). Thereafter, the bag Status is continuously checked and updated. If the Status changes to Off, then the bag tracking system alerts or notifies (e.g., via transmitting a signal, data, or information) the DDS Process Unit as to the change of the Status from ON to OFF (307). The DDS Process Unit executes a bag removal process (308) which is described in detail below with reference to FIG. 20. If the bag Status is On (304), then the bag tracking system updates (e.g., internally updates) a Location Reference (LR) parameter every time the bag reaches a new LR (305 and 306). Based on completing the internal update of the Location Reference, the bag tracking system (e.g., VTU) alerts or notifies the DDS Process Unit on the new bag LR by transmitting a relevant Bag Code and a new Location Reference (309). The DDS Process Unit thereafter updates at least one of the DDU and the cross-platform application (e.g., BagClaim Application) (310).

The bag tracking system according to an embodiment may use automatic tag readers or RFID readers to define bag Location References (LR) on the carousel. For example, an ATR may be installed or provided at or relative to each simulated or predefined Location Reference (LR) at the carousel. In this case, every ATR will have a specific location reference that is equivalent to the simulated Location Reference. Throughout the passage of a bag on carousel over the simulated Location Reference, a corresponding ATR will identify the bag by the attached tag allowing the DDS Process Unit to define or determine the bag location on the carousel.

In the example shown in FIG. 12, 89 ATRs are used. The ATRs may be connected to a signal processing unit to accurately define a bag Location Reference.

5.4 DDS Display Unit

A Dynamic Display Unit (DDU) according to an embodiment displays information about traveling bags on a carousel to help passengers distinguish from a distance their bags among look like bags. As described above, the displayed information of a specific bag accompanies the bag through its travel on the carousel.

Further, the DDU according to an embodiment notifies or informs a passenger on a balance of uncollected bags, shows a sequence of a bag on the carousel, displays warning messages, and/or provides tips to passengers as to the functionality of the DDU. In some embodiments, the DDU could also be used to display additional information, such as advertising messages. It is understood that the contents, format, design, and layout of messages to be displayed on the DDU could be adjusted, selected, and/or controlled by the DDS Process Unit.

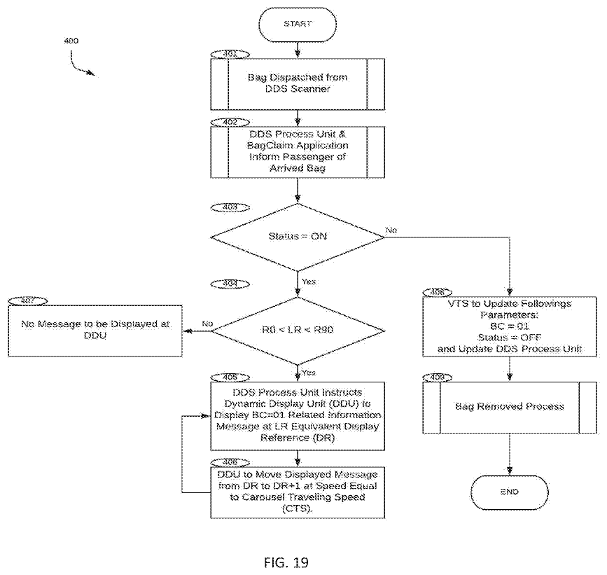

FIG. 19 is a flowchart of a method (400) of operating a Dynamic Display Unit according to an embodiment. Referring to FIG. 19, when a DDS Scanner dispatches a bag to the carousel conveyor belt inside an airport service area, the DDS Process Unit informs or controls to inform a passenger who owns the bag through, for example, the cross-platform application (e.g., BagClaim application) and/or a notification (e.g., SMS), that one of his or her bags has reached the carousel (401 and 402). Nothing regarding a bag may be displayed on DDU before the bag reaches bag claim area (407).

As long as the bag is traveling on the carousel, the bag Status is set to a first state (e.g., ON), and within the baggage claim area (in the example shown in FIG. 12, LR=R1 to LR=R89 or R0<LR<R90), the DDS Process Unit controls to provide the Dynamic Display Unit with related information to be displayed at the Display Reference (DR) that is equivalent to the bag Location Reference (403 to 405).

The Dynamic Display Unit moves the message or bag related information in the same direction as the carousel travels and at the same carousel traveling speed (406).

FIG. 20 is a flowchart of a method (500) of operating a Dynamic Display Unit when a bag is removed from a baggage carousel, according to an embodiment. Referring to FIG. 20, based on the bag (Bag Code BC=01) being removed from the carousel, the bag tracking system (e.g., video tracking process unit (VTU)) detects the Bag Reference Point (BR) that passes or exits the Simulated External Boundary Reference (501) (see, e.g., FIG. 16). This triggers or causes the bag tracking system (e.g., VTU) to change an internal corresponding bag Status from ON to OFF (502) and subsequently updates the DDS Process Unit on the change of the bag Status (503). The DDS Process Unit updates a DDS database (504) and instructs the DDU to replace a displayed information message by the related assigned notification message (506) that appears on the DDU for a predefined display duration before ceasing display. The DDS Process Unit also (e.g., simultaneously) instructs the DDU to update all related displayed information, e.g., to adjust the value of the balance of uncollected bags, adjust the sequence of the bags on the carousel, etc. (505). Furthermore, DDS Process Unit notifies the cross-platform application (e.g., BagClaim Application) as to the changes to the bag Status 507.

5.5 Inline Scanner

In case a passenger removes a bag from the carousel by mistake and then returns the bag to the carousel or belt, the bag tracking system (e.g., VTU) according to an embodiment may provide the returned bag with a new Bag Code (BC). In this case, the DDS Process Unit can identify the bag by using an inline scanner to read the bag tag information. Here, the inline scanner according to an embodiment may include an automatic tag reader and/or a video coding system to read the tag information of the bag in order to update a passenger of the new bag Status and resume the tracking procedure.

An operation, controlling method, and/or functionality according to various example embodiments as described above may be embodied as a program and stored in one or more of various types of recording media. In other words, a computer program that can be processed by various processors to execute a method and/or functionality described above may be stored in a recording medium, such as a non-transitory computer readable medium, for use.

The non-transitory computer readable medium refers to a medium that stores data semi-permanently rather than storing data for a very short time, such as a register, a cache, and a memory, and is readable by an apparatus. Specifically, the above-described various applications or instructions may be stored in a non-transitory computer readable medium such as a compact disc (CD), a digital versatile disk (DVD), a hard disk, a Blu-ray disk, a universal serial bus (USB) memory stick, a memory card, and a read only memory (ROM).

Although certain embodiments have been shown and described above, it will be appreciated by those skilled in the art that changes may be made to these embodiments without departing from the principles and spirit of the disclosure. Accordingly, the scope of the disclosure is not construed as being limited to the described embodiments, but is defined by the appended claims as well as equivalents thereto.

1. A dynamic display system for providing baggage information in real time, the dynamic display system comprising:
a memory storing instructions;
one or more displays; and
at least one processor configured to execute the instructions to:
obtain the baggage information corresponding to baggage of a passenger, and control to display, in real time during travel of the corresponding baggage along a baggage carousel, the obtained bag information to move, on a screen of the one or more displays, in synchronization with the corresponding baggage along the baggage carousel.

2. The dynamic display system of claim 1, wherein the bag information comprises at least one of a flight number corresponding to the baggage, a passenger name corresponding to the baggage, a passenger photo corresponding to the baggage, a bag sequence of the corresponding baggage on the carousel, a number of uncollected baggage of the passenger, a departure airport corresponding to the baggage, and a notification of heavy baggage indicating that the corresponding baggage is heavy.

3. The dynamic display system of claim 1, wherein the screen is a banner screen, ticker screen, or multi-display device that extends along an inner or outer perimeter of the baggage carousel or suspended over the baggage carousel.

4. The dynamic display system of claim 1, wherein the baggage information is controlled to move at a same speed and a same direction of the corresponding baggage so as to accompany the corresponding baggage as the corresponding baggage travels along the baggage carousel.

5. The dynamic display system of claim 2, wherein the bag information further comprises a notification of heavy baggage indicating that the corresponding baggage is heavy.

6. The dynamic display system of claim 2, wherein the at least one hardware processor is further configured to execute the instructions to, based on the corresponding baggage being removed from the baggage carousel, replace the displayed bag information with an indication of the number of uncollected baggage of the passenger and/or any other predetermined notification and to control to display the indication and/or the predetermined notification for a predetermined period of time.

7. The dynamic display system of claim 1, further comprising at least one of a scanner to identify each baggage loaded onto the baggage carousel.

8. The dynamic display system of claim 1, further comprising: a bag tracking unit for tracking the baggage as the baggage travels along the baggage carousel,
wherein the bag tracking unit comprises at least one of:
a video tracking processing device and one or more cameras;
one or more automatic tag reading devices; and
one or more Radio Frequency Identification (RFID) readers configured to read an RFID tag on the baggage as the baggage travels along the baggage carousel.

9. The dynamic display system of claim 1, further comprising a cross-platform application server configured to transmit the baggage information to at least one of a user terminal device and an interactive display device.

10. An electronic device for providing baggage information corresponding to baggage of a passenger, the electronic device comprising:
a memory storing instructions; and
at least one processor configured to execute the instructions to:
obtain, from a cross-platform application service, the baggage information, and
control to display the obtained baggage information corresponding to the baggage of the passenger, the displayed baggage information indicating a real time location of the corresponding baggage on a baggage carousel.

11. The electronic device of claim 10, wherein the at least one processor is further configured to execute the instructions to control to display information guiding the passenger from a flight area to the baggage carousel and information on facilities of an airport in which the baggage carousel is located, the information on the facilities comprising information on at least one of elevator locations, escalators, stairs, customs and/or passport control area, and specifically-designated or assigned customs and/or passport control lanes.

12. The electronic device of claim 10, wherein the at least one processor is further configured to execute the instructions to control to display a notification whenever checked-in baggage of the passenger is loaded onto the baggage carousel.

13. The electronic device of claim 10, wherein the at least one processor is further configured to execute the instructions to display a notification whenever checked-in baggage of the passenger is removed from the baggage carousel.

14. The electronic device of claim 10, wherein the at least one processor is further configured to execute the instructions to display a notification whenever checked-in baggage of the passenger is removed from the baggage carousel if the passenger is determined to be away from the baggage carousel.

15. The electronic device of claim 10, wherein the displayed baggage information comprises a scaled down schematic plan corresponding to the baggage carousel, and an indicator of the baggage positioned on and moving along the schematic plan in correspondence with a real time location of the baggage on the baggage carousel.

16. The electronic device of claim 10, wherein the displayed baggage information comprises a scaled down schematic plan corresponding to the baggage carousel, and indicator of a removed baggage positioned on where the baggage has been removed from, and a time when the baggage has been removed.

17. A method of providing baggage information in real time, the method comprising:
obtaining the baggage information corresponding to baggage of a passenger; and
controlling to display, in real time during travel of the corresponding baggage along a baggage carousel, the obtained bag information to move, on a screen of one or more displays, in synchronization with the corresponding baggage along the baggage carousel, wherein the bag information comprises at least one of a flight number corresponding to the baggage, a passenger name corresponding to the passenger, a bag sequence of the corresponding baggage on the carousel, a number of uncollected baggage of the passenger, and a departure airport corresponding to the baggage.

18. The method of claim 17, wherein the screen is a banner screen, ticker screen, or multi-display device that extends along an inner perimeter of the baggage carousel or suspended over the carousel.

19. The method of claim 17, wherein the baggage information is controlled to move at a same speed and a same direction of the corresponding baggage so as to accompany the corresponding baggage as the corresponding baggage travels along the baggage carousel.

20. A non-transitory computer-readable recording medium having recorded thereon instructions executable by at least one hardware processor to perform the method of claim 17.
